(19) United States
(12) Patent Application Publication
(10) Pub. No.: US 2005/0258776 A1
(43) Pub. Date: Nov. 24, 2005

(54) Plasma display apparatus and driving method thereof

(76) Inventor: Seong Hak Moon, Seoul (KR)

Correspondence Address: MCKENNA LONG & ALDRIDGE LLP, 1900 K STREET, NW, WASHINGTON, DC, 20006, US

(21) Appl. No.: 11/131,208

(22) Filed: May 18, 2005

(30) Foreign Application Priority Data
May 18, 2004 (KR) 10-2004-0035342

(51) Int. Cl. G09G 3/10

(52) U.S. Cl. 315/169.4

(57) ABSTRACT

A plasma display apparatus and a method of driving the same are disclosed. The plasma display apparatus includes a plasma display panel and a scan driving part and a sustain driving part each including an energy recovery circuit having a first energy storage part and a second energy storage part such that discharge is generated a plurality of times by one sustain pulse when sustain pulses are supplied to the plasma display panel.

This Nonprovisional application claims priority under 35 U.S.C. § 119(a) on Patent Application No. 10-2004-0035342 filed in Korea on May 18, 2004 the entire contents of which are hereby incorporated by reference.

### BACKGROUND OF THE INVENTION

1. Field of the Invention

The present invention relates to a plasma display panel, and more particularly to a plasma display apparatus that includes an energy recovery circuit and a method of driving the same.

2. Description of the Background Art

In general, a plasma display panel (PDP) emits light from a fluorescent body by ultraviolet (UV) rays of 147 nm generated when an inactive mixed gas such as He+Xe or Ne+Xe is discharged to display images including characters and graphics.

FIG. 1 is a perspective view illustrating the structure of a conventional three-electrode AC surface discharge type PDP having discharge cells arranged in a matrix. Referring to FIG. 1, a three-electrode AC surface discharge type PDP 100 includes a scan electrode 11a and a sustain electrode 12a formed on a top substrate 10 and an address electrode 22 formed on a bottom substrate 20. The scan electrode 11a and the sustain electrode 12a are formed of a transparent electrode, for example, indium-tin-oxide (ITO), respectively. Metal bus electrodes 11b and 12b for reducing resistance are formed in the scan electrode 11a and the sustain electrode 12a, respectively. A top dielectric layer 13a and a protective layer 14 are laminated on the top substrate 10 on which the scan electrode 11a and the sustain electrode 12a are formed. Wall charges generated during plasma discharge are accumulated on the top dielectric layer 13a. The protective layer 14 prevents the top dielectric layer 13a from being damaged by sputtering generated during plasma discharge and improves efficiency of emitting secondary electrons. MgO is commonly used as the protective layer 14.

On the other hand, a bottom dielectric layer 13b and a partition wall 21 are formed on a bottom substrate 20 on which the address electrode 22 is formed and the surfaces of the bottom dielectric layer 13b and the partition wall 21 are coated with a fluorescent body layer 23. The address electrode 22 is formed to intersect the scan electrode 11a and the sustain electrode 12a. The partition wall 21 is formed to run parallel with the address electrode 22 to prevent ultraviolet (UV) rays and visible rays generated by discharge from leaking to an adjacent discharge cell. The fluorescent body layer 23 is excited by the UV rays generated during plasma discharge to generate any one visible ray among red (R), green (G), and blue (B) visible rays. An inactive mixed gas such as He+Xe or Ne+Xe for discharge is implanted into a discharge space of discharge cells partitioned by the partition wall 21 provided between the top substrate 10 and the bottom substrate 20. A method of driving a conventional PDP having such a structure will be described with reference to FIG. 2.

FIG. 2 illustrates driving waveforms for describing the method of driving the conventional PDP. Referring to FIG. 2, the conventional PDP is driven such that each sub-field is divided into a reset period for initializing the entire screen, an address period for selecting a cell, and a sustain period for sustaining the discharge of the selected cell.

First, the reset period is divided into a set-up period SU and a set-down period SD. A rising ramp waveform Ramp-up is simultaneously applied to all of scan electrodes Y in the set-up period SU. Discharge occurs in the cells of the entire screen due to the rising ramp waveform. Positive wall charges are accumulated on address electrodes X and sustain electrodes Z and negative wall charges are accumulated on the scan electrodes Y due to the set-up discharge. In the set-down period SD, a falling ramp waveform Ramp-down that starts to fall from a positive voltage lower than the peak voltage of the rising ramp waveform to thus fall to a ground voltage GND or a negative specific voltage level after the rising ramp waveform is supplied generates weak erase discharge in cells to erase a part of the excessively formed wall charges. The wall charges to the amount that can stably generate address discharge uniformly reside in the cells due to the set-down discharge.

In the address period, a negative scan pulse Scan is sequentially applied to the scan electrodes Y and, at the same time, a positive data pulse data is applied to the address electrodes X in synchronization with the scan pulse. When difference in voltage between the scan pulse and the data pulse is added to the wall voltage generated in the reset period, address discharge is generated in the cell to which the data pulse is applied. Wall charges to the amount that can generate discharge when a sustain voltage is applied are formed in the cells selected by the address discharge. A positive DC voltage Zdc is supplied to the sustain electrodes Z to reduce the difference in voltage between the sustain electrodes Z and the scan electrodes Y in the set-down period and the address period such that mis-discharge between the sustain electrodes Z and the scan electrodes Y is not generated.

In the sustain period, sustain pulses sus are alternately applied to the scan electrodes Y and the sustain electrodes Z. In the cells selected by the address discharge, the wall voltage in the cells is added to the sustain pulse such that the sustain discharge, that is, display discharge is generated between the scan electrodes Y and the sustain electrodes Z whenever each sustain pulse is applied. Also, after the sustain discharge is completed, a ramp waveform Ramp-ers having small pulse width and voltage level is supplied to the sustain electrodes Z to erase the wall charges that reside in the cells of the entire screen.

On the other hand, an energy recovery circuit for generating the sustain pulses applied to the scan electrodes or the sustain electrodes in the sustain period will be described with reference to FIG. 3.

FIG. 3 illustrates the energy recovery circuit included in the conventional plasma display apparatus. Referring to FIG. 3, the operation of the energy recovery circuit is comprised of four steps.

First, in the first step, a first switch S1 is turned on and second to fourth switches S2, S3, and S4 are turned off. When the switches are operated as described above, LC resonance is generated and the energy stored in a capacitor C_{S} is charged in a capacitor C_{P} of a PDP through an inductor L.

Then, in the second step, the third switch S3 is turned on and the first, second, and fourth switches S1, S2, and S4 are turned off. When the switches are operated as described above, the sustain voltage Vs is supplied to the capacitor C_{P} of the PDP through the third switch that is turned on.

In the third step, the second switch S2 is turned on and the first, third, and fourth switches S1, S3, and S4 are turned off. When the switches are operated as described above, the energy of the capacitor C_{P} is discharged to the capacitor C_{S} through the inductor L to collect the energy.

Finally, in the fourth step, the fourth switch S4 is turned on and the first to third switches S1, S2, and S3 are turned off. When the switches are operated as described above, the potential of the capacitor C_{P} falls to a ground level.

The conventional energy recovery circuit supplies the sustain pulses through the above-described processes. The conventional energy recovery circuit collects the energy in the periods where the sustain pulses fall and supplies the sustain pulses in the periods where the sustain pulses rise using the collected energy to reduce power consumption.

However, since the energy collected by the conventional energy recovery circuit is equal to or smaller than Vs/2, there are limitations on increasing energy efficiency.

### SUMMARY OF THE INVENTION

Accordingly, an object of the present invention is to solve at least the problems and disadvantages of the background art.

It is an object of the present invention to provide a plasma display apparatus capable of improving energy efficiency and brightness and a method of driving the same.

In order to achieve the above object, a plasma display apparatus comprises a plasma display panel and a scan driving part and a sustain driving part each including an energy recovery circuit having a first energy storage part and a second energy storage part such that discharge is generated a plurality of times by one sustain pulse when sustain pulses are supplied to the plasma display panel.

The energy recovery circuit comprises an energy recovery switching part for supplying energy stored in the first energy storage part to a plasma display panel and for collecting the energy supplied to the plasma display panel in the first energy storage part to be stored in the first energy storage part, a peaking pulse applying part for supplying energy stored in the second energy storage part to the plasma display panel after the energy stored in the first energy storage part is supplied to the plasma display panel, a resonating part for generating a peaking pulse when the energy stored in the second energy storage part by the peaking pulse applying part is applied to the plasma display panel, and a sustain driving part for having the plasma display panel be in a ground level after the energy supplied to the plasma display panel sustained in a sustain voltage is collected in the first energy storage part after the peaking pulse is generated.

The energy recovery switching part comprises a first switching element and a second switching element. The body diode of the first switching element and the body diode of the second switching element are arranged in inverse directions.

The first switching element is turned on when the energy stored in the first energy storage part is supplied to the plasma display panel. The second switching element is turned on when the energy supplied to the plasma display panel is collected in the first energy storage part to be stored in the first energy storage part.

The voltage of the peaking pulse is larger than the sustain voltage.

According to a method of driving a plasma display apparatus of the present invention, one sustain pulse comprises a peaking pulse when sustain pulses are supplied to a plasma display panel such that discharge is generated a plurality of times.

The supply of the sustain pulses to the plasma display panel comprises the steps of supplying energy stored in a first energy storage part to a plasma display panel, supplying energy stored in a second energy storage part to the plasma display panel after the energy stored in the first energy storage part is supplied to the plasma display panel to generate a peaking pulse, and having the plasma display panel be in a ground level after the plasma display panel is sustained in a sustain voltage after the peaking pulse is generated.

Discharge is generated two times.

The voltage of the peaking pulse is larger than the sustain voltage.

### BRIEF DESCRIPTION OF THE DRAWINGS

The present invention will be described in detail with reference to the following drawings in which like numerals refer to like elements.

FIG. 1 is a perspective view illustrating the structure of a conventional three-electrode AC surface discharge type plasma display panel (PDP) having discharge cells arranged in a matrix.

FIG. 2 illustrates driving waveforms for describing a method of driving the conventional PDP.

FIG. 3 illustrates an energy recovery circuit included in a conventional plasma display apparatus.

FIG. 4 schematically illustrates a plasma display apparatus according to the present invention.

FIG. 5 is a circuit diagram of an energy recovery circuit according to the present invention.

FIG. 6 illustrates waveforms in accordance with the operation of the energy recovery circuit according to the present invention.

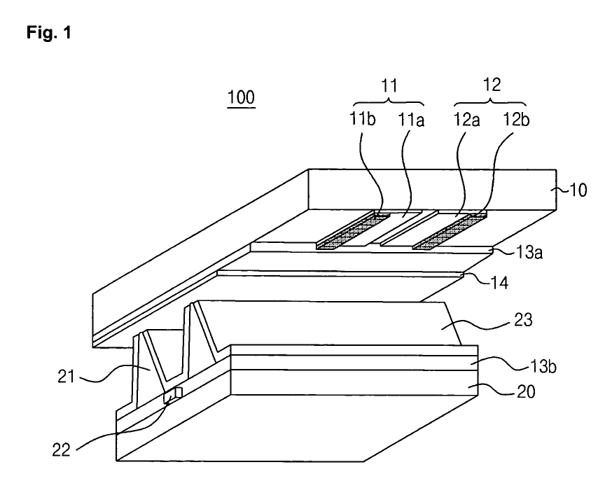

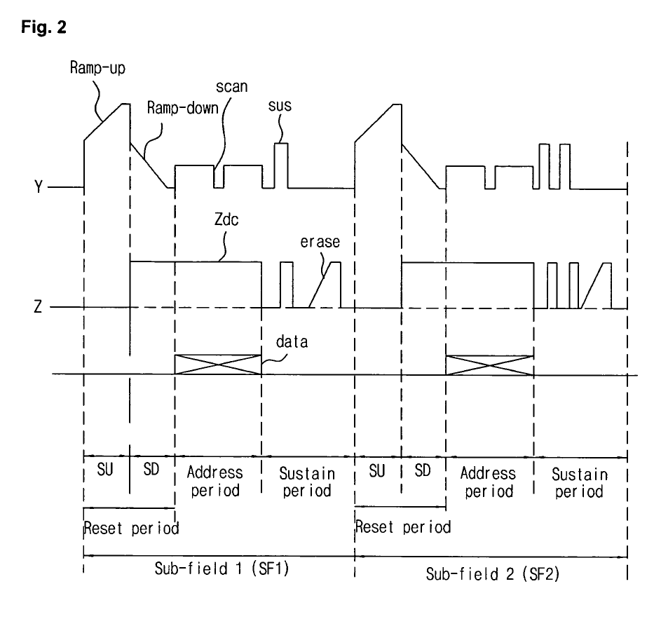

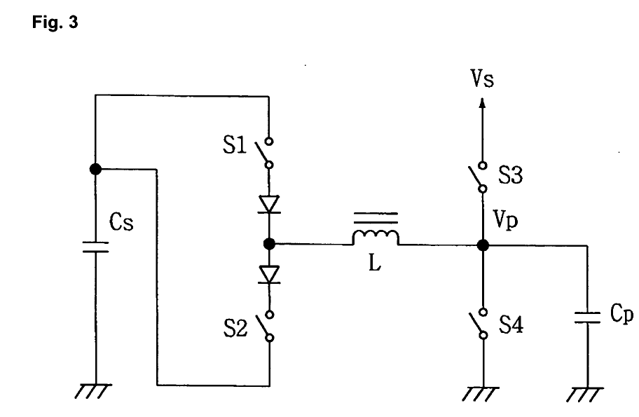

### DETAILED DESCRIPTION OF PREFERRED EMBODIMENTS

Preferred embodiments of the present invention will be described in a more detailed manner with reference to the drawings.

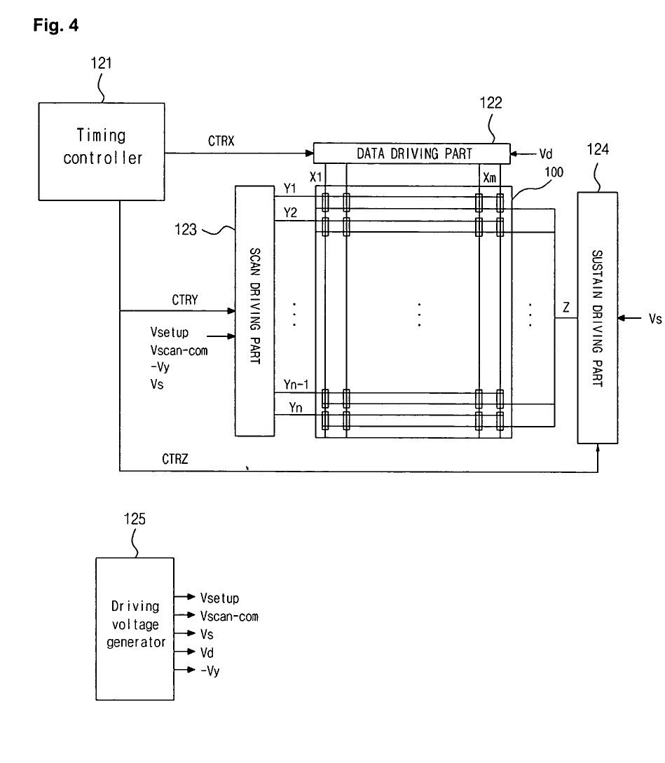

FIG. 4 schematically illustrates a plasma display apparatus according to the present invention.

As illustrated in FIG. 4, the plasma display apparatus according to the present invention includes a plasma display panel (PDP) 100, a data driving part 122 for supplying data to address electrodes X1 to Xm formed on a bottom substrate (not shown) of the PDP 100, a scan driving part 123 for driving scan electrodes Y1 to Yn, a sustain driving part 124 for driving sustain electrodes Z that are common electrodes, a timing control part 121 for controlling the data driving part 122, the scan driving part 123, and the sustain driving part 124 when the PDP is driven, and a driving voltage generating part 125 for supplying necessary driving voltage to the respective driving parts 122, 123, and 124.

In the PDP 100, a top substrate (not shown) and a bottom substrate (not shown) are attached to each other by uniform distance. On the top substrate, a plurality of electrodes, for example, the scan electrodes Y1 to Yn and the sustain electrodes Z are formed to make pairs. On the bottom substrate, the address electrodes X1 to Xm are formed so as to intersect the scan electrodes Y1 to Yn and the sustain electrodes Z.

Data that is inverse gamma corrected and error diffused by an inverse gamma correcting circuit and an error diffusing circuit that are not shown and then, is mapped by a sub-field mapping circuit in each sub-field is supplied to the data driving part 122. The data driving part 122 samples and latches data in response to a timing control signal CTRX from the timing control part 121 and supplies the data to the address electrodes X1 to Xm.

The scan driving part 123 supplies a rising ramp waveform Ramp-up and a falling ramp waveform Ramp-down to the scan electrodes Y1 to Yn under the control of the timing control part 121 in a reset period. Also, the scan driving part 123 sequentially supplies the scan pulse scan of a scan voltage −Vy to the scan electrodes Y1 to Yn under the control of the timing controller 121 in an address period and supplies a sustain pulse generated by an energy recovery circuit included therein to the scan electrodes in a sustain period. At this time, the sustain pulse includes a peaking pulse such that discharge occurs a plurality of times.

The sustain driving part 124 supplies the bias voltage of a sustain voltage Vs to the sustain electrodes Z under the control of the timing control part 121 in a period where the falling ramp waveform Ramp-down is generated and in an address period and the sustain driving circuit included therein alternately operates together with the sustain driving circuit included in the scan driving part 123 in the sustain period such that the sustain driving part 124 supplies a sustain pulse sus to the sustain electrodes Z. At this time, the sustain pulse also includes a peaking pulse such that discharge occurs a plurality of times.

On the other hand, as described above, the sustain pulses may be supplied to both the scan electrodes and the sustain electrodes in a state where each of the sustain pulses generated by the energy recovery circuit included in the scan driving part or the sustain driving part includes a peaking pulse. However, the sustain pulses may be supplied to the scan electrodes or the sustain electrodes in a state where each of the sustain pulses includes a peaking pulse. Also, the sustain pulses may be supplied to the scan electrodes or the sustain electrodes in a state where not all but some of the sustain pulses generated by the energy recovery circuit include peaking pulses, respectively.

The timing control part 121 receives vertical/horizontal synchronizing signals and a clock signal, generates timing control signals CTRX, CTRY, and CTRZ for controlling the operation timings and the synchronizations of the respective driving parts 122, 123, and 124 in the reset period, the address period, and the sustain period, and supplies the timing control signals CTRX, CTRY, and CTRZ to the corresponding driving parts 122, 123, and 124 to control the respective driving parts 122, 123, and 124.

On the other hand, a sampling clock for sampling data, a latch control signal, and a switch control signal for controlling the on/off times of a sustain driving circuit and a driving switch element are included in the data control signal CTRX. A switch control signal for controlling the on/off times of the sustain driving circuit and the driving switch element in the scan driving part 123 is included in the scan control signal CTRY. A switch control signal for controlling the on/off times of the sustain driving circuit and the driving switch element in the sustain driving part 124 is included in the sustain control signal CTRZ.

The driving voltage generating part 125 generates a set-up voltage Vsetup, a scan common voltage Vscan-com, a scan voltage −Vy, a sustain voltage Vs, and a data voltage Vd. Such driving voltages may change due to the composition of a discharge gas or the structure of a discharge cell.

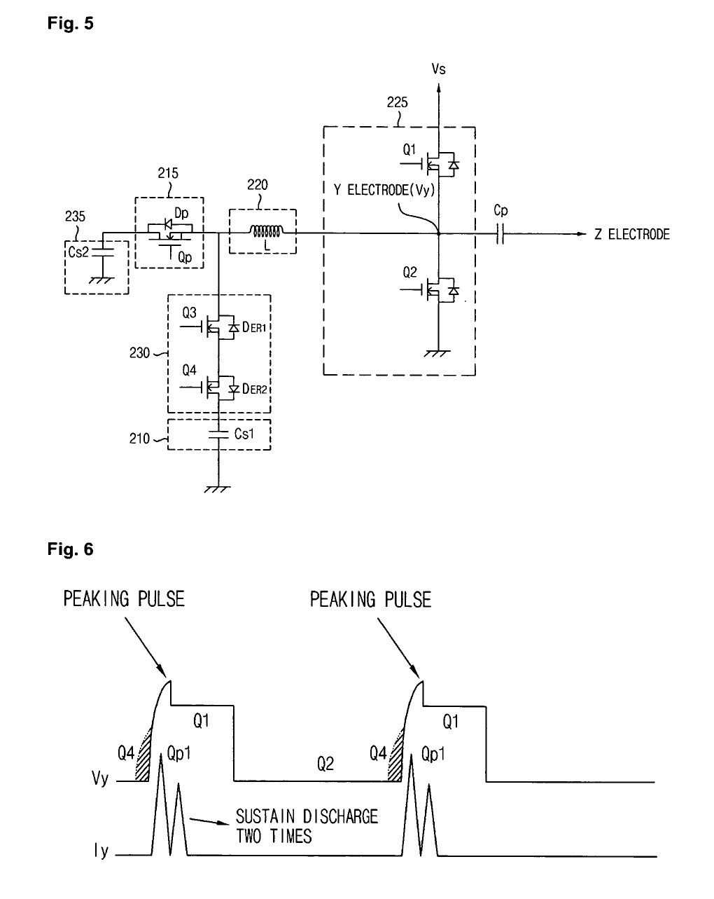

According to the plasma display apparatus having such a structure, the energy recovery circuits included in the scan driving part and the sustain driving part and the waveforms of the sustain pulses generated by the operations of the energy recovery circuits will be described with reference to FIGS. 5 and 6.

FIG. 5 is a circuit diagram of an energy recovery circuit according to the present invention and FIG. 6 illustrates waveforms in accordance with the operation of the energy recovery circuit according to the present invention.

As illustrated in FIG. 5, the energy recovery circuit according to the present invention includes a peaking pulse applying part 215 for applying peaking pulses, an energy recovery switching part 230, and a first energy storage part 210 such that energy is stored in the first capacitor C_{S}1 of the first energy storage part 210 and the second capacitor C_{S}2 of the second energy storage part 235 when a panel C_{P} is charged and discharged to drive the panel C_{P} again. At this time, the energy recovery switching part 230 includes two field effect transistor (FET) switching elements.

First, when the fourth switch Q4 of the energy recovery switching part 230 is turned on, the first capacitor C_{S}1 of the first energy storage part 210 supplies the stored energy to a panel Q_{P} through the fourth switch Q4 and the body diode D_{ER1} of a third switch Q3.

Next, when the peaking pulse switch Q_{P}1 of the peaking pulse applying part 215 is turned on, the energy stored in the second capacitor C_{S}2 of the second energy storage part 235 is implanted into the panel C_{P} through the coil L of a resonating part 220 and the scan electrodes such that a peaking pulse larger than a sustain voltage is applied to the scan electrodes.

As described above, when the peaking pulse switch Q_{P} of the peaking pulse applying part 215 is turned on, the first capacitor C_{S}1 of the first energy storage part 210 supplies the stored energy in the direction of the second capacitor C_{S}2 through the peaking pulse switch Q_{P} of the peaking pulse applying part 215.

That is, the peaking pulse switch Q_{P} of the peaking pulse applying part 215 is turned on after the first energy storage part 210 applies a predetermined voltage to the panel C_{P} such that the peak current instantaneously applied to the panel C_{P} is relaxed to some extent.

Therefore, noise generated by a high voltage and high peak current is removed such that waveforms are stabilized and that almost no heat is generated during sustain driving.

Next, when the voltage of a peaking pulse is maximal, the first switch Q1 of a sustain driving part 225 is turned on and the peaking pulse switch Q_{P} and the third switch Q3 of the energy recovery switching part 230 are turned off. Therefore, the sustain voltage Vs is applied to the scan electrodes and, at the same time, the second capacitor C_{S}2 of the second energy storage part 235 is charged through the body diode D_{P} of the peaking pulse switch Q_{P}.

Sustain discharge occurs twice in the above process. That is, sustain discharge occurs at the point of time where the peaking pulse is applied and sustain discharge occurs again when the sustain voltage is applied to the scan electrodes Y.

Next, when the third switch Q3 of the energy recovery switching part 230 is turned on, the charges charged in the panel C_{P} is charged in the first capacitor C_{S}1 of the first energy storage part 210 through the third switch Q3 and the body diode D_{ER2} of the fourth switch Q4 to be used again when the sustain pulse rises next time.

That is, the energy recovery circuit according to the present invention uses all the energy of the first energy storage part 210 and the second energy storage part 235 when the panel C_{P} is charged. However, when the panel C_{P} is discharged, the charges charged in the panel C_{P} is again charged in the first capacitor C_{S}1 of the first energy storage part 210 through the third switch Q3 of the energy recovery switching portion 230 such that energy is stored only in the first capacitor C_{S}1 of the first energy storage part 210.

Also, the second capacitor C_{S}2 of the second energy storage part 235 is charged through the body diode D_{P} of the peaking pulse switch Q_{P} at the point of time where the first switch Q1 of the sustain driving part 225 is turned on such that the sustain voltage is applied. Therefore, there is almost no energy consumption when the first switch Q1 is switched such that power consumption is reduced.

Since the energy recovery circuit according to the present invention uses the energy stored in the first energy storage part 210, discharge regions increase as marked with the oblique lines of FIG. 6 to thus improve brightness.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

As described above, according to the present invention, discharge occurs a plurality of times using peaking pulses when sustain pulses are supplied to a PDP such that it is possible to improve energy efficiency and brightness.

1. A plasma display apparatus comprising:
a plasma display panel; and
a scan driving part and a sustain driving part each including an energy recovery circuit having a first energy storage part and a second energy storage part such that a plurality of discharge is generated by one sustain pulse when sustain pulses are supplied to the plasma display panel.

2. The plasma display apparatus as claimed in claim 1, wherein the energy recovery circuit comprises:
an energy recovery switching part for supplying energy stored in the first energy storage part to a plasma display panel and for collecting the energy supplied to the plasma display panel in the first energy storage part to be stored in the first energy storage part;
a peaking pulse applying part for supplying energy stored in the second energy storage part to the plasma display panel after the energy stored in the first energy storage part is supplied to the plasma display panel;
a resonating part for generating a peaking pulse when the energy stored in the second energy storage part by the peaking pulse applying part is applied to the plasma display panel; and
a sustain driving part for making the plasma display panel to be a ground level after the energy supplied to the plasma display panel sustained in a sustain voltage is collected in the first energy storage part, after the peaking pulse is generated.

3. The plasma display apparatus as claimed in claim 2,
wherein the energy recovery switching part comprises a first switching element and a second switching element, and
wherein the body diode of the first switching element and the body diode of the second switching element are arranged in inverse directions.

4. The plasma display apparatus as claimed in claim 3,
wherein the first switching element is turned on when the energy stored in the first energy storage part is supplied to the plasma display panel, and
wherein the second switching element is turned on when the energy supplied to the plasma display panel is collected in the first energy storage part to be stored in the first energy storage part.

5. The plasma display apparatus as claimed in claim 2, wherein the voltage of the peaking pulse is higher than the sustain voltage.

6. A method of driving a plasma display apparatus, wherein one sustain pulse comprises a peaking pulse when sustain pulses are supplied to a plasma display panel for generating a plurality of discharge.

7. The method as claimed in claim 6, wherein the supply of the sustain pulses to the plasma display panel comprises the steps of:
supplying energy stored in a first energy storage part to a plasma display panel;
supplying energy stored in a second energy storage part to the plasma display panel after the energy stored in the first energy storage part is supplied to the plasma display panel to generate a peaking pulse; and
making the plasma display panel to be a ground level after the plasma display panel is sustained in a sustain voltage, after the peaking pulse is generated.

8. The method as claimed in claim 6, wherein the plurality of discharge is two times discharge.

9. The method as claimed in claim 7, wherein the voltage of the peaking pulse is higher than the sustain voltage.
